(19) United States
(12) Patent Application Publication
(10) Pub. No.: US 2008/0038002 A1
(43) Pub. Date: Feb. 14, 2008

(54) IMAGE FORMATION DEVICE, INFORMATION PROCESSING DEVICE, RECORDING MEDIUM, LOG GENERATION METHOD, AND COMPUTER DATA SIGNAL

(75) Inventor: Masafumi ONO, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/736,022

(22) Filed: Apr. 17, 2007

(30) Foreign Application Priority Data
Aug. 11, 2006 (JP) 2006-219743

(51) Int. Cl. G03G 15/00

(52) U.S. Cl. 399/2

(57) ABSTRACT

An image formation device receives formation information having a predetermined structure and formed based on document information which is an object for image formation, executes a process of image formation based on the formation information, and sends the formation information to a transmission destination via a communication medium.

### CROSS-REFERENCE TO RELATED APPLICATIONS

This application is based on and claims priority under 35 U.S.C 119 from Japanese Patent Application No. 2006-219743 filed on Aug. 11, 2006.

### BACKGROUND

1. Technical Field

The present invention relates to an image formation device, an information processing device, a recording medium, log generation method, and computer data signal.

2. Related Art

In recent years, recording of the processes carried out by an image processing device become widely introduced in order to cope with information leakage. In addition, recording the processed image data as a log has also been considered.

### SUMMARY

According to one aspect of the invention, there is provided an image formation device including a receiving section that receives formation information having a predetermined structure and formed based on document information which is an object for image formation, an execution section that executes a process of image formation based on the formation information, and a transmission section that sends the formation information to a transmission destination via a communication medium.

### BRIEF DESCRIPTION OF THE DRAWINGS

An exemplary embodiment of the present invention will be described in detail based on the following figures, wherein:

FIG. 1 is a block diagram showing a structure of a system including an image formation device and an information processing device according to an exemplary embodiment of the present invention;

FIG. 2 is a functional block diagram showing an example of a document processing device connected to the image formation device according to the exemplary embodiment of the present invention;

FIG. 3 is a functional block diagram showing an example of the image formation device according to the exemplary embodiment of the present invention; and

FIG. 4 is a diagram explaining an example of a structure of a recording area provided by the information processing device according to the exemplary embodiment of the present invention.

### DETAILED DESCRIPTION

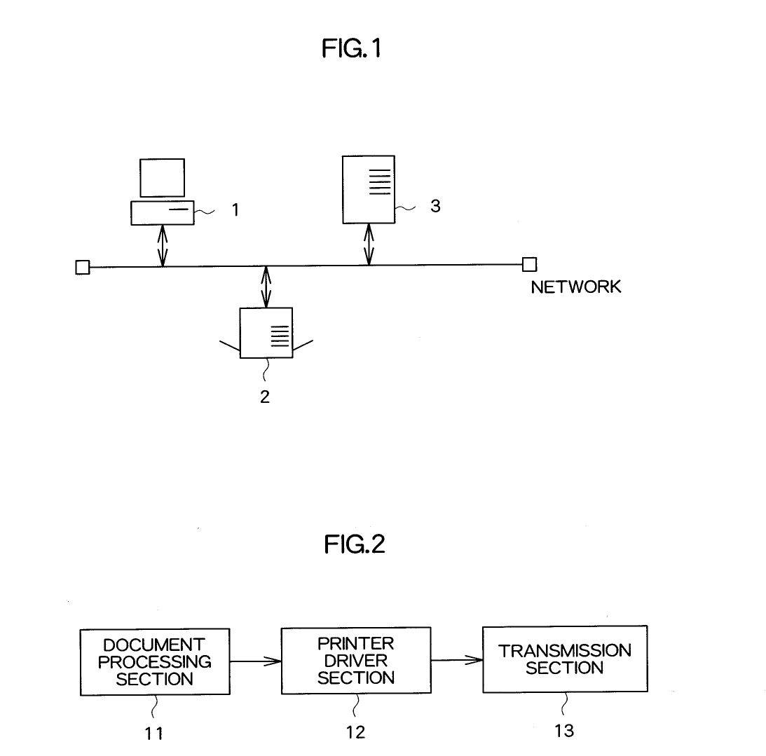

A document processing system including an image formation device and an information processing device according to an exemplary embodiment of the present invention is constructed having a structure such as is shown in FIG. 1. That is, this document processing system is constructed having a user side personal computer (PC) 1 which serves as a document processing device, a printer device 2 which serves as an image formation device, and a file server 3 which serves as an information processing device. These devices are mutually connected via a communication medium. The communication medium here may be a network, for example. The network, however, is not an exclusive example, and a serial communication line, such as a USB (Universal Serial Bus), IEEE 1394, and so forth, and a parallel communication line may be similarly applicable. Data communication initiated by the user side PC 1 directing the printer device 2 is not necessarily carried out via a circuit line, but may be carried out via a storage medium, such as a memory device, or the like.

Here, the user side PC 1 contains a program execution device, such as a processor, at least either a memory element or a disk device, or a computer readable recording medium, which stores a program to be executed by the processor, and a circuit, such as a network interface, for sending and receiving information via a communication medium.

The user side PC 1 is constructed having, in terms of function, a document processing section 11, a printer driver section 12, and a transmission section 13, as shown in FIG. 2.

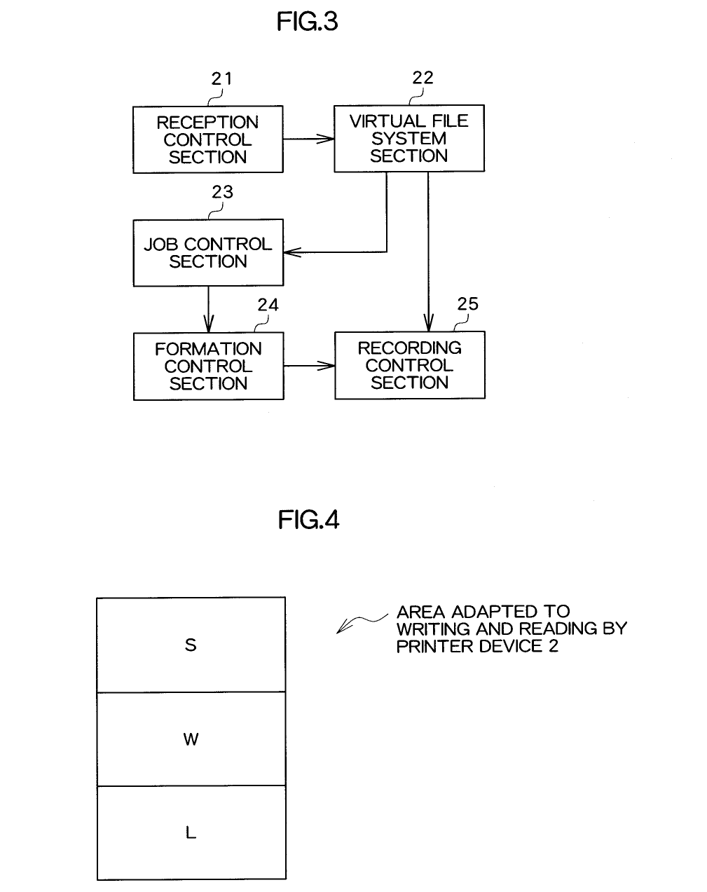

The printer device 2 forms an image based on an instruction sent from the user side PC 1. In this exemplary embodiment, the printer device 2 includes a program execution device, such as a processor, and at least either a memory element or a disk device, or a computer readable recording medium, which stores a program to be executed by the processor. The printer device 2 additionally has a circuit, such as a network interface, for sending and receiving information via a communication medium. Specifically, the printer device 2 is constructed having, in terms of function, a reception control section 21, a virtual file system section 22, a job control section 23, a formation control section 24, and a recording control section 25, as shown in FIG. 3.

The file server 3 which serves as an information processing device contains a program execution device, such as a processor, and at least either one of a memory element and a disk device, or a computer readable recording medium, which stores a program to be executed by the processor. The file server 3 contains a storage device, such as a hard disk, or the like. Operated by the processor, the file server 3 can store a file received via a network in at least a part of the storage device. As a specific example, the file server 3 has a server, such as an NFS (Network File System), an SMB (Server Message Block), a WebDAV (see RFC2518), and so forth, operating for file transfer.

In this exemplary embodiment, due to the service provided by the file server 3, a spool area S, a working area W, and a log recording area L are available in the area inside the storage device, as shown in FIG. 4.

In the following, operations of the respective sections of the user side PC 1 and the printer device 2 will be described. The document processing section 11 of the user side PC 1 produces and displays a document (document information), utilizing various application programs, such as a word processor, and so forth, according to an instruction operation carried out by the user. Upon receipt of an instruction which requests formation of an image of a document to be processed, or a process object document, the document processing section 11 outputs the process object document to the printer driver section 12.

Based on the document sent from the document processing section 11, the printer driver section 12 produces formation information having a data structure acceptable to the printer device 2. It should be noted that the formation information is described according to a rule determined in advance by the printer device 2 (that is, information in a spool data format). Based on the formation information, the printer device 2 will produce bitmap graphics, and the produced bitmap graphics will be formed on a medium, such as a sheet of paper.

The printer driver section 12 receives process information (user name, specification of either colored or monochrome, designation of resolution, the number of copies, and so forth) relevant to document image formation, which is designated in the instruction sent from the user. Then, the printer driver section 12 sends, together with the produced formation information, the received process information relevant to the image formation to the transmission section 13. The transmission section 13 produces print job information which contains the formation information and the relevant process information, both sent from the printer driver section 12, and sends the print job information to the printer device 2.

Having received the print job information from the user side PC 1, the reception control section 21 of the printer device 2 issues a unique identifier (a job identifier) to the received print job information. Then, the reception control section 21 stores the received print job information and the job identifier issued uniquely thereto in a virtual file system realized by the virtual file system section 22 in a related manner.

Here, the virtual file system section 22 operates as a client in a manner corresponding to the service provided by the file server 3, transferring a file to the file server 30. For example, for the file server 3 operating as an NFS server, the virtual file system section 22 operates as an NFS client. The virtual file system section 22 makes it possible to virtually utilize the file system ensured inside the storage device in the file server 3 as if the file system were provided in the printer device 2. It should be noted that for the file server 3 utilizing an SMB or a WebDAV, the virtual file system section 22 carries out a process corresponding to that system type to thereby virtually use the file system in the storage device in the file server 3 as if the file system were provided in the printer device 2. That is, in the virtual filing system described above, the virtual file system section 22 actually sends the data having been stored in the virtual file system to the server process of the file server 3, or a predetermined transmission destination, via a communication medium.

In this exemplary embodiment, the virtual file system includes a spool area S, a working area W, and a log recording area L, as described above. The reception control section 21 stores the received print job information in a manner associated with a job identifier in the spool area S.

Every time the formation control section 24 becomes ready for image formation, the job control section 23 selects as focused information one of the print job information items stored in the virtual file system in the order of reception, for example. Then, the job control section 23 sends the selected focused information item and the associated job identifier to the formation control section 24. Further, the job control section 23 moves the focused information item stored in the spool area S to the working area W. Specifically, the job control section 23 may copy the focused information item from the spool area S to the working area W, and delete the focused information item in the spool area S.

The formation control section 24 converts the formation information contained in the focused information into bitmap graphics data with reference to the corresponding process information. For example, suppose that the process information contains an instruction requesting formation of a monochrome image at resolution 600 dpi (600 dots per one inch). In this case, the formation control section 24 produces monochrome bitmap graphics at a resolution of 600 dpi based on the formation information.

Further, with reference to the summary information, the formation control section 24 controls the printer engine so as to form bit map graphics based on the produced bitmap graphics data on a medium such as a sheet of paper. For example, suppose that the summary information contains an instruction requesting image formation for N number of copies. In this case, bitmap graphics are formed N times with respect to the same bitmap graphics data.

With the image information completed based on the focused information, the formation control section 24 outputs as history information the number of copies actually formed, the formation condition actually employed, and at least a part of the summary information of the focused information to the recording control section 25 together with the job identifier associated with the focused information.

Upon receipt of the history information and the job identifier, the recording control section 25 reads print job information which is stored in the working area W of the virtual file system in a manner being associated with the input job identifier. Then, the recording control section 25 stores at least a part of the print job information and the history information in a manner being associated with each other in the log recording area L. The print job information subjected to the above-described reading from the working area W may be deleted from the working area W.

In the above, it is unnecessary to store the whole of the print job information in the log recording area L, and storage of the formation information alone, for example, is sufficient. In this case, the formation information and the history information are stored in the log recording area L in a manner being associated with each other.

It should be noted here that the formation information and the history information both stored in the log recording area L of the virtual file system are actually present in the storage device of the file server 3, which is realized through the operation of the virtual file system section 22 and the server operating inside the file server 3.

In this manner, the file server 3 has the formation information concerning the image data subjected to image formation and the history information containing associated information such as image formation condition, stored in the storage device therein.

In this exemplary embodiment, the formation information having been output to the printer device 2 is stored in the file server 3, in addition to the information concerning the image formation condition, the user name, and so forth, as a record of the image formation carried out by the printer device 2. Therefore, should there be a desire to refer to an image having been formed based on a print job which satisfies a predetermined condition for the user name, or the like, later, the formation information associated with that print job may be output again to the printer device 2 where the relevant image is formed.

As described above, in this exemplary embodiment, the document processing system holds intact the spool data having been supplied to the image formation device, such as a printer device, as a record of the image data used in the formation process. This allows the printer device, or the like, to produce the log of the image data without application of a process which requires many calculation resources, such as conversion of bitmap data into a PDF, and so forth. Further, as the log of the image data is the spool data itself which is acceptable to the image formation device, such as a printer device, or the like, an image can be readily formed based on the spool data should it be desired to refer to the image later. That is, ease of reference is not deteriorated.

Here, it should be noted that there may be a possibility in the above-described situation that the connection to the file server 3 via a communication line is disconnected, or there is a request to store data having an amount in excess of the capacity of the area provided by the file server. When it is determined, like in these cases, that the reception control section 21 cannot store the formation information or the like in the virtual file system (that is, when the size of the vacant area in the log recording area L is smaller than a predetermined threshold), the reception control section 21 may refrain from issuing a job identifier. In these cases, image formation is refrained from until the file server 3 becomes ready for storage of the job data.

Further, although it is described in the above that the spool area S, the working area W, and so forth, are ensured in the area within the storage device provided by the file server 3, in the case where the printer device 2 incorporates a storage section (such as a hard disk device, or the like) which is sufficient to store and hold the data which can be stored in the spool area S and the working area W, the spool area S and the working area W may be ensured in the storage section. In this case, the file server 3 may provide an area which contains a log recording area L, or an area not ensured in the storage section, so that the virtual file system section 22 of the printer device 2 sends the data which should be stored in the area provided by the file server 3 to the virtual file system.

In the case where the storage section in the printer device 2 can provide a spool area S, as described above, and when the processor of the printer device 2 determines that storage of formation information or the like in the virtual file system is impossible, a temporary log recording area L′ may be ensured in the storage section so that the image formation may be carried out while storing the associated formation and history information in the temporary log recording area L′.

Then, when the file server 3 becomes available to receive the job data, the content stored in the temporary log recording area L′ may be copied to the log recording area L provided by the file server 3, with the content in the log recording area L′ deleted.

The content stored in the log recording area L provided by the file server 3 may be deleted by the printer device 2. For example, when the spool area S does not have sufficient empty capacity to store the received print job information, at least a part of the information stored in the log recording area L may be deleted to thereby ensure a sufficient free space in the spool area S before storing the received print job information therein.

In deletion, the printer device 2 may selectively delete the information items stored in the log recording area L, beginning with one having an older storage time and date. In the case where a storage area provided by another server, such as a file server, is available, and when the printer device 2 determines that storage of the formation information in the virtual file system is impossible, the following may be carried out.

That is, the printer device 2 uses the storage area provided by the other server as a virtual file system to ensure a log recording area L or the like in that storage area, and then stores the formation and history information in the log recording area L.

For example, a list of information specifying a server which is available to operate as a file server 3, for example, may be stored in the printer device 2, so that the printer device 2 can select another file server with reference to the list.

In this exemplary embodiment, the file server 3 may produce image information having a structure different from that of the formation information, based on the formation information stored in the log recording area L. Then, the file server 3 may accumulatively store the produced image information in a manner being associated with the original formation information (or, alternatively, the file server 3 may accumulatively store the produced image information as a substitute for the original formation information). The image information referred to here has a different structure from that of the formation information and may include a PDF, for example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image formation device, comprising:
a receiver that receives formation information having a predetermined structure and formed based on document information which is an object for image formation;
an execution section that executes a process of image formation based on the formation information; and
a transmitter that sends the formation information to a transmission destination via a communication medium.

2. The image formation device according to claim 1, wherein the transmitter sends the formation information to the transmission destination via the communication medium by storing the formation information in a storage medium for accumulating the formation information in the transmission designation.

3. An information processing device, comprising:
a receiver that receives formation information having a structure acceptable to an image formation device and formed based on document information which is an object for image formation;
a production section that produces image information having a structure different from the structure of the formation information, based on the received formation information; and
an accumulator that accumulates the image information.

4. A computer readable recording medium storing a program causing a computer to execute a log generation process, the process comprising:
receiving formation information having a predetermined structure and formed based on document information which is an object for image formation;
executing a process of image formation based on the formation information; and
sending the formation information to a transmission destination via a communication medium.

5. A log generation method comprising:
receiving formation information having a predetermined structure and formed based on document information which is an object for image formation;
executing a process of image formation based on the formation information; and
sending the formation information to a transmission destination via a communication medium.

6. A computer data signal embodied in a carrier wave for enabling a computer to perform a process for generating log information, the process comprising:
receiving formation information having a predetermined structure and formed based on document information which is an object for image formation;
executing a process of image formation based on the formation information; and
sending the formation information to a transmission destination via a communication medium.
